(19) United States
(12) Patent Application Publication
(10) Pub. No.: US 2002/0171243 A1
(43) Pub. Date: Nov. 21, 2002

(54) Sealing system for media-carrying parts

(76) Inventor: Harry Jost, Knittlingen (DE)

Correspondence Address: J. Rodman Steele Jr, Akerman Senterfitt & Eidson, Post Office Box 3188, West Palm Beach, FL, 33402-3188, US

(21) Appl. No.: 10/031,305

(22) PCT Filed: May 9, 2001
(86) PCT No.: PCT/EP01/05236

(30) Foreign Application Priority Data
May 16, 2000 (DE) 100 23 692.8

(51) Int. Cl. F16L 33/18

(52) U.S. Cl. 285/354; 285/349; 285/379

(57) ABSTRACT

The invention relates to a sealing system for media-carrying parts, especially for use in asepsis, comprising a sealing ring (14), preferably a toroidal sealing ring, which is placed on a sealing seat for the purpose of sealing the parts. Said sealing seat is constituted by a sealing channel (22) that substantially surrounds the sealing ring. The sealing channel (22) is composed of sealing surfaces (21a, 21b) of both parts (12, 13) and defines between said parts and between said sealing surfaces a sealing groove (30) into which the sealing ring (14) is deformed when the parts are axially braced against each other until they come into contact. A separating joint (41) adjoins the sealing channel on a side facing away from the sealing groove (30). The sealing channel (22) has at least one expansion chamber (35, 57a, 57b) that deviates from the undeformed cross-section of the sealing ring. Said expansion chamber (35, 57a, 57b) is arranged substantially opposite the sealing groove (30). The sealing ring (14) is deformed into the expansion chamber (35, 57a, 57b) by outer influences, especially by the bracing force for joining the parts.

### FIELD OF APPLICATION AND PRIOR ART

The invention relates to a sealing system for media-carrying parts according to the preamble of claim 1.

In many industrial sectors, e.g. in the pharmaceutical, foods or cosmetics industries, connections for media-carrying parts must satisfy extremely strict requirements in order to e.g. permit use in aseptic or sterile processes. Asepsis and sterility is e.g. required in processes for increasing the keeping quality of dairy products or during the production of foods without the use of preservatives. The minimum requirements made on such connections are laid down in various quality control guidelines, such as e.g. the GMP (Good Manufacturing Practice). Requirements are made with regards to the design, processing, material and surface of the connections. It has been found that frequently the seal constitutes the “weakest link” of such connections, so that the sealing system of such connections with respect to the environment is of decisive importance in order to maintain small germ numbers or sterility in the processes in question. The nature of the seal and its fixing to the connection are important.

DE 197 35 427 describes a sterile connection between two parts, particularly between two pipes. The connection has two reception areas, namely a radial, inner reception area and an outer reception area connected thereto for receiving the seals. The seal placed in the inner reception area is deformed on joining together the two tubes, so that it substantially completely fills the reception area. It ensures that bacteriologically the connection is tight from the inside to the outside. However, if there is a pressure drop in the pipe leaks occur if the seal is drawn into the sealing gap and is deformed inwards to such an extent that it no longer engages on the walls of the reception area. The second seal positioned in the outer reception area is intended to prevent this and ensure that bacteriologically a seal also exists from the outside to the inside.

### PROBLEM AND SOLUTION

The problem of the invention is to provide a sealing system for media-carrying parts, which is simple and inexpensive to manufacture and offers further improved security against bacteriological contamination.

For solving this problem the invention proposes a connection with the features of claim 1. Further developments of the invention form the subject matter of the subclaims.

The term sealing system in the sense of the present application is more particularly understood to mean a detachable sealing system, such as a screw, flange or clamping connection or the like. Media-carrying parts are components which can come into contact with random media, such as gases, liquids, etc. and e.g. in the form of pipes, tubes, containers, valves, etc. Thus, a sealing system for media-carrying parts is preferably a joint connection between two lines, e.g. pipes, between two container components or between a line and a container, e.g. between a supply pipe and a reactor. However, it is also possible to use the sealing system in valves or the like, e.g. as a valve housing seal and/or as a spindle sealing system. The sealing system for media-carrying parts can be used for the most varied processes, but is preferably used for aseptic purposes. Aseptic applications are understood to mean low-germ or sterile processes under which pharmaceuticals, foods, cosmetics, etc. can be produced.

The sealing system according to the invention is characterized in that the sealing channel has expansion chambers diverging from the undeformed cross-sectional shape of the sealing ring. The sealing channel largely surrounds the sealing ring and is formed from sealing surfaces of the two media-carrying parts. The sealing channel can in each case be constructed as a type of groove in each of the parts. In particular, such a groove is formed on each of the two media-carrying parts, which leads to the formation of the sealing channel on joining the two parts. The sealing channel is substantially adapted to the undeformed, particularly circular or oval cross-sectional shape of the sealing ring, but with the exception of areas of the sealing gap and the expansion chambers. Under external influences, particularly on bracing the parts, the sealing ring located in the sealing channel deforms into the sealing gap directed towards the media area and on the other into the expansion chambers. Bracing of the parts is more particularly understood to mean the application of a clearly defined pretension on joining the two parts, in which the sealing ring is pressed on the sealing surfaces and consequently seals both towards the media area and to the environment. Pretensioning is in particular brought about in that the two parts are brought onto a metallic stop. The specific sealing pressure on pressing together the parts is e.g. in the range of the elastic deformation of the material of the parts. It can be close to the yield point (0.2%−yield strength) of the material of the parts, e.g. 20 to 80% of the yield point value. The sealing pressure value can be approximately 30 to 140 Newton/mm².

In conventional sealing systems the expansion chamber is solely constituted by the sealing gap at the media area. In the least favourable case the sealing ring can deform into the media area where it forms a type of bead, which projects from the media-carrying walls. Between the media-carrying wall and the bead a dead volume can form where, particularly when using liquid media, liquid residues, e.g. puddles, can collect after emptying and form an ideal nutrient medium for germs and bacteria. This is not the case with the connection according to the invention. As stated, the sealing ring deforms both into the sealing gap and also into the expansion chambers.

In a further development of the invention the sealing surfaces of the connection are formed from main sealing surfaces and secondary sealing surfaces. The main sealing surfaces are understood to mean the contact surfaces between the sealing ring and the media-carrying parts, where during the bracing of the parts there is an increased sealing pressing-out pressure and consequently the main sealing action occurs. The main sealing surfaces preferably bound the sealing gap directed towards the media area or the separating gap between the two media-carrying parts and seal the sealing system both from the inside and from the outside, i.e. from the media area to the environment and from the outside to the inside. The secondary sealing surfaces, which are wider than the main sealing surfaces, are preferably located in the vicinity of the at least one expansion chamber (main expansion chamber) and provide an additional sealing action. Preferably the maximum contact pressure occurs at the main sealing surfaces on bracing the parts. This leads to a fixing of the sealing ring with the media-carrying parts on said main sealing surfaces. As a result the sealing ring bead deformed into the sealing gap following bracing cannot slide into the media area or be retracted into the sealing gap (elevator effect). Thus, pockets of bacteria which have been deposited in the sealing gap at the transition between the sealing ring and the media area wall are not drawn into the sealing surface by a forward and return movement of the bead, such as can e.g. occur with pressure or temperature fluctuations in the media area, so as to prevent cleaning away thereof. In addition it is possible to prevent damage to the sealing ring material, e.g. in the form of microcracks, which could occur as a result of the forward and return movement of the bead.

According to a further development of the invention the sealing channel and its expansion chambers are so dimensioned as a function of the dimensions of the sealing ring that the surface of the sealing ring part deforming into the sealing gap is substantially aligned with the media-carrying walls of the parts. Thus, there is essentially a planar transition between the wall and the sealing gap of the connection.

According to a further development of the invention the expansion chambers are arranged in such a way that the sealing ring deforms substantially symmetrically to at least one central axis of its cross-section. The size and shape of an expansion chamber, preferably facing the sealing gap, essentially corresponds to the size and shape of the sealing gap, so that symmetrically to an axially central axis of the cross-section of the sealing ring, two substantially equally large parts of the sealing ring deform in bead-like manner into the sealing gap or the expansion chamber. In addition, symmetrically to a radial central axis two beads can deform into the two grooves of the media-carrying parts. As a result during the bracing of the two parts the sealing ring is prevented from rotating in the annular channel, which would be possible with an asymmetrical deformation of the sealing ring. This could lead to a disproportionately high material stressing of the sealing ring, where the latter could be destroyed.

In a further development of the invention the main expansion chamber is formed by a cross-sectional shape of the sealing channel receiving the sealing ring diverging from the preferably semicircular basic cross-sectional shape of the sealing ring. This cross-sectional shape can be a recessed profile compared with the semicircular shape, e.g. in the form of a pocket of the channel halves forming the sealing channel. For example, the cross-sectional profile can be formed form a semicircular arc and more weakly curved portions tangentially connected thereto. The profile constituted by the two channel halves can also comprise two circular arcs (almost semicircles) displaced apart axially with their centre points. Preferably the main sealing surfaces are directly connected to the main expansion chambers and are in particular formed in the vicinity of portions of the parts engaging in the sealing cross-section. The sealing ring is deformed during bracing mainly in the main expansion chambers at the bottom of groove-like sealing channel halves, i.e. perpendicular to the sealing gap. Thus, only a small part of the sealing ring is deformed as a bead into the sealing joint.

In particularly preferred manner the sealing system has, in addition to the main expansion chambers, a secondary expansion chamber which is provided at the transition between the sealing channel and a separating gap formed by the two parts and which is substantially axial, i.e. directed approximately tangentially relative to the sealing ring or sealing channel. The secondary expansion chamber can have all conceivable cross-sectional shapes, e.g. round, oval, etc. However, it more particularly forms a cross-sectionally bead-like depression, which is connected to the sealing channel. The secondary expansion chamber is radially pronounced and has rounded edges ensuring that the sealing ring is not damaged during its deformation. In particular the transition between the secondary expansion chamber and the sealing channel is formed with a S-shaped transition, i.e. is not purely tangential to the sealing channel.

The separating gap connected axially to the secondary expansion chamber is preferably so narrow that the sealing ring deformation ends beforehand, i.e. the sealing ring is not deformed into the separating gap. The sealing gap is no more than 1/100 to 1/20, particularly 1/80 to 1/50 of the cross-sectional dimension of the sealing ring. As a result of this sealing ring-free separating gap the two parts can be very precisely axially guided during the moving together and during bracing.

In conventional sealing systems the boundary edge of the sealing gap connected to the sealing surface of the sealing channel is constructed in such a way that the media-carrying wall of the parts passes with a radius into the sealing channel. To said radius is connected a straight portion of the boundary edge, which in turn passes into a connecting, second radius. The application of radii is intended to prevent damage to the sealing ring during bracing, which would be possible with sharp edges. However, it arises that the shape of the boundary edge during working is not “round-straightround”, but instead due to the working tolerance the two radii pass into one another like a type of Gothic pointed arch. This once again leads to a sharp edge, which can damage the sealing ring.

In a further development of the invention this is prevented in that the edges bounding the sealing gap are provided with a uniform, predetermined radius independent of the tolerance-variable thickness of the edges. The radius is approximately 1/20 to ⅓, preferably 1/10 to ⅕ of the cross-sectional dimension of the sealing ring. The sealing ring is preferably constructed in such a way that its cross-sectional dimension compared with the nominal width of the media-carrying parts, which can e.g. be between 50 and 400 mm, is small. The cross-sectional dimension is preferably in the range of 1/150 to 1/10, particularly 1/100 to 1/50 of the nominal width of the media-carrying parts. As stated, the cross-sectional shape of the sealing ring is adapted to the sealing channel of the connection, e.g. it is round or oval in the undeformed state.

The sealing ring is normally made from a flexible, rubbery material with medium-appropriate characteristics regarding temperature and chemical stability. It can be a hard metal or an iron-titanium alloy, e.g. ferrotitanate. Compared with the two media-carrying parts, the sealing ring can be the harder component. The parts must therefore be deformable under the bracing force or tension in order to bring about a sealing action.

In a further development of the invention the sealing system of the media-carrying parts has a screw coupling, which in particular has a coating preventing corrosion during screwing. For this purpose e.g. a hard metal coating, preferably a titanium-nitride coating is suitable.

The sealing system can also be a flange connection, in which the contact pressure is produced by screwing the flanges. Sealing systems constructed as joint connections are preferably welded into a pipeline or to a container and for this purpose particularly orbital welding is suitable.

The parts can be made from hard materials, e.g. stainless steel. However, other materials are also suitable from which the entire parts can be made, e.g. ceramic or plastics materials. Plastic sealing systems can e.g. be produced by an injection moulding process.

The advantages of the present invention are that on joining together and bracing the media-carrying parts, the seal is deformed in such a way that there are no dead volumes or gaps, which are potential contamination sources. For this purpose and in addition to the sealing gap on the sealing channel there are areas into which the sealing ring is deformed. Two of these areas are main expansion chambers, which are constructed in the form of pockets on the bottom of the groove-like sealing channel halves and into which is deformed the main part of the sealing ring on bracing the parts. The secondary expansion chamber faces the sealing gap, i.e. on a side opposite to the media area. Due to the fact that under the bracing force the sealing ring is deflected not only radially inwards, but also axially to both sides and radially outwards, it is ensured that no bead projecting over the walls of the parts is formed on the sealing gap, where germs or bacteria could be deposited. Thus, the connection according to the invention in particular complies with the high demands made for sterile or low-germ processes.

These and further features can be gathered from the claims, description and drawings and the individual features, both singly and in the form of subcombinations, can be implemented in an embodiment of the invention and in other fields and can represent advantageous, independently protectable constructions for which protection is claimed here.

The subdivision of the application into individual sections and the subheadings in no way restrict the general validity of the statements made thereunder.

### BRIEF DESCRIPTION OF THE DRAWINGS

The invention is described hereinafter relative to two preferred embodiments and the attached drawings, wherein show:

FIG. 1 A part sectional view through a sealing system.

FIG. 2 On a larger scale detail Z in FIG. 1.

FIG. 3A sectional plan view of a sealing system between an inspection glass and a container.

FIG. 4 On a larger scale part of FIG. 3.

FIG. 5 On a larger scale detail Z of FIG. 1, with a representation of the contact pressure.

### DETAILED DESCRIPTION OF THE EMBODIMENTS

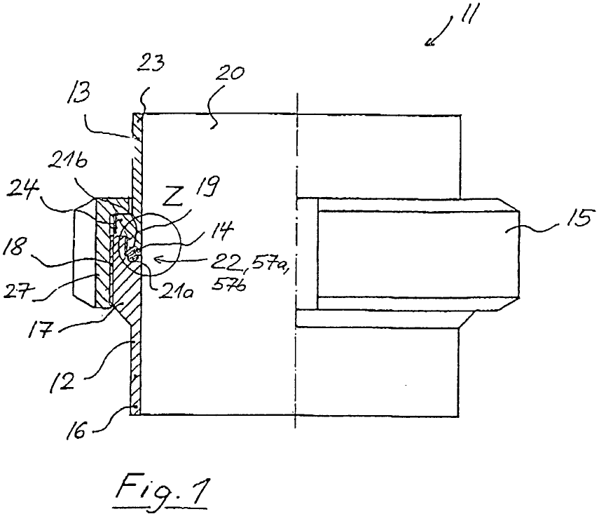

FIG. 1 shows a screw coupling 11, such as in particular is used for joining two pipes. The screw coupling 11 comprises four parts, a threaded connector 12, a collar connector 13, a sealing ring 14 and a box nut 15. The threaded connector 12 and collar connector 13 are preferably made from stainless steel, e.g. chrome-nickel-molybdenum steel. The standard nominal widths of such screw couplings 11 are in the range 6 to 100 mm (DN 6 to 100). The screw couplings are designed for operating pressures of up to 60 bar. The sealing ring 14 is e.g. an O-ring, which is suitable for foods. It is preferably made from rubber, e.g. acrylonitrile-butadiene rubber. The surfaces of the screw coupling 11 are suitable for cleaning-in-part (CIP) cleaning and sterilization-in-part (SIP) sterilization.

The threaded connector 12 comprises a pipe section 16, to which is connected a larger diameter threaded section 17. The pipe section 16 is welded to a not shown pipe. Orbital welding has proved to be a particularly suitable welding process for sterile or low-germ processes. The transition between the threaded section 7 and pipe section 16 is conical. The threaded section 17 has an external thread 18, which extends from the transition between the pipe section 16 and the threaded section 17 to the end of the threaded section 17. At the threaded section-side end of the threaded connector 17 is formed a radially circumferential slit 19 directed towards the media area 20. At the foot of the slit 19 is formed a sealing surface 21a in the form of a groove with semicircular cross-section, which on joining together the threaded connector 12 and collar connector 13 forms part of the sealing channel 22 to be described hereinafter.

The collar connector 13 has a pipe section 23 and a flange section 24. The pipe section 23 of the collar connector 13 can also be welded into a not shown pipeline. The flange section 24 is a step-like extension on the outer surface of the pipe section 23. The flange section 24 has towards the flange-side end of the collar connector 13 a step 25, which passes into a radially circumferential web 26. At the head of the web 26 is formed a sealing surface 21b in the form of a groove with a semicircular cross-section, which forms part of the sealing channel 22 on joining together the threaded connector and collar connector 12, 13.

The box nut 15 is used for bracing the threaded and collar connectors 12, 13. It has a threaded section 27 with an internal thread 28, as well as a stop collar 29 for fixing the box nut 15 to the collar connector 13. The internal thread 28 has a hard metal coating in order to prevent corrosion during the screwing together of the box nut 15 with the threaded connector 12.

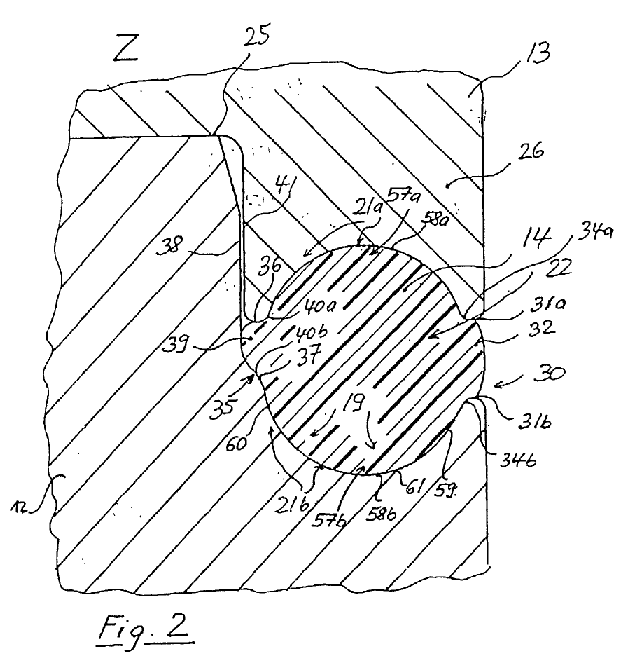

FIG. 2 shows on a larger scale the sealing channel 22 formed by the threaded connector 12 and collar connector 13. When the threaded connector 12 and collar connector 13 are joined together, the sealing channel 22 is essentially formed by the two sealing surfaces 21a, 21b on the threaded connector 12 or collar connector 13. Towards the media area 20 the sealing channel 22 issues into a sealing gap. It has an oval cross-sectional shape diverging from the undeformed semicircular cross-section of the sealing ring 14. As shown in FIG. 5, the sealing channel is formed by two channel halves, which in each case comprise a semicircular arc 61a, 61b and more weakly curved portions 59a, 59b, 60a, 60b tangentially connected thereto. The centres 62, 63 of the semicircular arcs 61a, 61b are mutually axially displaced. This cross-sectional shape diverging from the semicircular shape makes it possible to construct two pocket-like main expansion chambers 57a, 57b at the bottom of the particular sealing channel half. The sealing gap 30 is a radially circumferential clearance, which is formed by a boundary edge 31a of the collar connector 13 and a boundary edge 31b of the threaded connector 12, which maintain a mutual spacing after the joining together of the collar and threaded connectors 12, 13. The boundary edges 31a, 31b have a uniform radius in the range 1/20 to ⅓, preferably 1/10 to ⅕ of the cross-sectional dimension of the sealing ring 14. The sealing ring 14 has a circular cross-section in the undeformed state. Compared with the nominal width of the screw coupling 11, it has a cross-sectional dimension in the range 1/150 to 1/10, particularly 1/100 to 1/50 of the nominal width of the screw coupling 11. For example, in the case of a screw coupling nominal width of 100 mm, this would be 1 mm. In the undeformed state, i.e. under the bracing force during screwing, a bead is formed on the sealing ring 14 and extends into the sealing gap 30 and is aligned with the inner walls of the threaded and collar connectors 12, 13. The boundary edges 31a, 31b of the threaded and collar connectors 12, 13 form at the transition between said bead 32 and the remaining sealing ring 14, two facing, inner main sealing surfaces 34a, 34b, which bring about the actual sealing action. Facing the sealing gap 30, the sealing channel 22 issues into the secondary expansion chamber 35. The secondary expansion chamber 35 is axially bounded by a boundary edge 36, remote from the media area 20, on the web 26 of the collar connector 13 and a S-shaped transition 37 between the groove 21b and the radial, lateral surface 38 of the slit 19 on the threaded connector 12.

In the deformed state, the secondary expansion chamber 35 receives a further bead 39 of the sealing ring 14. The boundary edge 36, seal 14 and S-shaped transition 37 form at the transition of said bead 39 with the remaining sealing ring 14, two facing, outer main sealing surfaces 40a, 40b, which bring about the actual sealing action from the outside to the inside. The secondary expansion chamber 35 passes into an axially directed separating gap 41, which on joining together the threaded and collar connectors 12, 13 constitutes a clearance between a lateral surface of the web 26 and the radial lateral surface 38 of the slit 19. The lateral surface 38 on threaded connector 12 is bevelled to ensure optimum fixing of the threaded and collar connectors 12, 13.

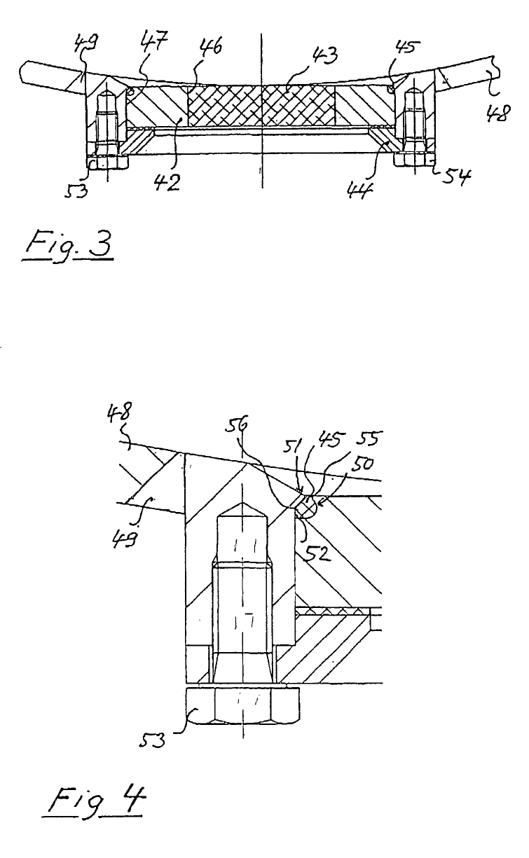

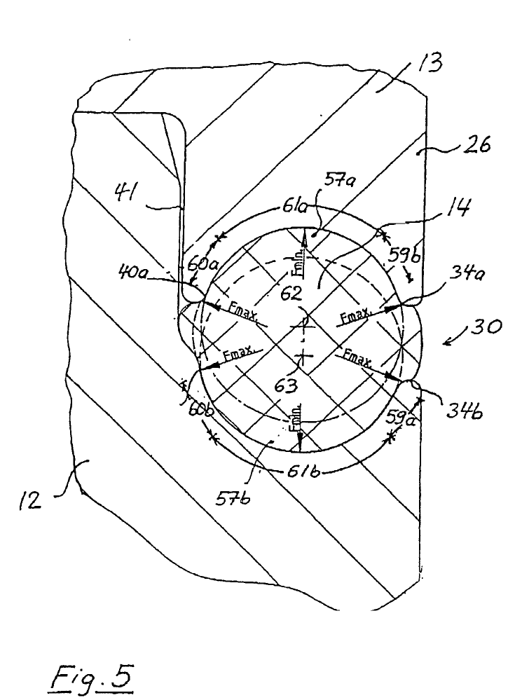

FIGS. 3 and 4 show a connection between an inspection glass 43 and a container part, as a further embodiment. The connection comprises a collar connector 42 with an inspection glass 43, a retaining ring 44 and an O-ring 45. The inspection glass 43 can be a continuous inspection glass or a porthole inspection glass. The material used is preferably borosilicate glass. The collar connector 42 is made from steel, e.g. a chrome-nickel-molybdenum steel.

The collar connector 42 is centrally provided with a through opening 46 in which is inserted the inspection glass 43. The collar connector 42 is fixed on a reception opening 47 of a container and is secured by the retaining ring 44. The reception opening 47 is a type of window projecting from the container 48 and in which is inserted the collar connector 40 with the inspection glass 43. For the purpose of fixing the collar connector 42 use is made of fastening screws 53, 54, whose screw head acts on the retaining ring 44 and secures both the latter and the collar connector 42. The reception window 47 of the container 48 is sealed towards the remaining container 48 by a wedge-shaped gap seal 49. Between the inner wall of the reception window 47 and the outer wall of the collar connector 42 is formed a sealing channel 50 (FIG. 4). The sealing channel 50 is formed by a radially circumferential recess on the collar connector 42 and a straight, inclined surface, connected thereto, at the end of the reception window 47. To the sealing channel 50, towards the media side is connected a sealing gap 51 and in inclined manner facing the same a reception area 52, into which is deformed the O-ring 45 located in the sealing channel 50 under the bracing force of the fastening screw 53.

Functional Description

For the production of the sealing system the annular grooves, i.e. the halves of the sealing channel 22 are made by precision turning, particularly with a sectional steel. Plastic sealing systems can be produced by injection moulding. Particular attention is paid to the radius located on the apex of the boundary edges 31a, 31b, which is not formed by two lateral radii, but instead with a sectional steel from the apex, i.e. in FIG. 2 from the top or bottom. This ensures that the first part coming into contact with the sealing ring 14 from the media area, i.e. the apex of the boundary edges 31a, 31b is rounded and not pointed. If the boundary edges 31a, 31b, as a result of manufacturing tolerances are very narrow, due to radii formation no “pointed arches” but instead an optionally shallow rounded arch is produced. Thus, it is also not possible to cut into the seal there during deformation leading to the formation of pockets of bacteria which could not be cleaned.

In the case of the screw coupling 11 shown in FIGS. 1 and 2, for assembly purposes firstly the sealing ring 14 is inserted in the groove-like sealing surface 21b with a semicircular cross-section at the foot of the slit 19 on threaded connector 12. The sealing ring 14 only comes into contact with the main sealing surfaces 34a, 34b, 40a, 40b, whereas between the secondary sealing surfaces 58a and 58b and the sealing ring 14 there is initially a gap corresponding to the main expansion chambers 57a, 57b. The collar connector 13 is then mounted on the threaded connector 12 until there is a metallic stop between the flange section 24 of the collar connector 13 and the threaded section 17 of the threaded connector 12. Between the lateral surface of the slit 19 of the threaded connector 12 and the lateral surface of the web 26 on the collar connector 13 an axially directed separating gap 41 forms. For bracing the threaded and collar connectors 12, 13 the box nut 15 is now screwed onto the external thread 18 of the threaded connector 12 until a metallic stop is formed between the stop of the box nut 15 and the flange on the collar connector 13. The sealing ring 14 is deformed in such a way that parts thereof are deformed into the main expansion chambers 57a, 57b and a bead 32 is deformed into the sealing gap 30 on media area 20 and another bead 39 is deformed into the secondary expansion chamber 35 facing the sealing gap 30. The pressing force is distributed in such a way that on the main sealing surfaces 34a, 34b, 40a, 40b the maximum pressing force occurs (Fmax; FIG. 5). The boundary edge 31a, 31b, 36, 37 of the threaded and collar connectors 12, 13 there press into the sealing ring 14. However, a minimum pressing fore (Fmin; FIG. 5) prevails at the secondary sealing surfaces 58a, 58b on the bottom of the main expansion chambers 57a, 57b.

In the case of the sealing system described in FIGS. 3 and 4 between an inspection glass 43 and a container 48, initially the O-ring 45 is placed in the collar connector 42. Then the collar connector 42 is introduced into the reception window 47 of container 48 and is axially fixed in the slide-in direction on the inclined surface at the end of the reception window 47. The retaining ring 44 is then shoved into the reception window 47 on the collar connector and the latter is fixed with the aid of the fastening screws 53, 54 to the reception window 47. Thus, the collar connector 47 is also axially secured against dropping out counter to the slide-in direction. Under the bracing force of screw 53, 54, the O-ring 45 is deformed into the sealing channel 50 in such a way that one bead 55 is deformed into the sealing gap 51 on the media area 20 and another bead 56 is deformed into the expansion chamber 52, which faces in inclined manner the sealing gap 51.

1. Detachable sealing system for media-carrying parts, particularly for aseptic applications, with a sealing ring (14), preferably a toroidal sealing ring, fixable to the sealing seat of the parts for the purpose of sealing the same, the sealing seat being formed by a sealing channel (22) substantially surrounding the sealing ring (14) and which is formed from the sealing surfaces (21a, 21b) of both parts and between the parts and between the sealing surfaces (21a, 21b) is formed a sealing gap (30) directed towards the media area (20) into which the sealing ring (14) is deformed if the parts are axially braced in stop manner against one another, whilst on a side remote from the sealing gap (30) a separating gap (41) is connected to the sealing channel (22), characterized in that the sealing channel (22) has at least one expansion chamber (35, 57a, 57b) diverging from the undeformed cross-sectional shape of the sealing ring (14) into which the latter is deformed under the bracing force for connecting the parts.

2. Sealing system according to claim 1, characterized in that the sealing surfaces (21a, 21b) comprise main sealing surfaces (34a, 34b, 40a, 40b), which are adjacent to the sealing gap (30) or separating gap (41) and secondary sealing surfaces (58a, 58b) which are located in the vicinity of at least one expansion chamber (35, 57a, 57b), an increased sealing contact pressure prevailing on the preferably narrow main sealing surfaces (34a, 34b, 40a, 40b).

3. Sealing system according to claim 1 or 2, characterized in that the expansion chamber (35, 57a, 57b) is constructed in such a way that the sealing ring (14) is deformed substantially symmetrically to an axial and/or radial central axis of its cross-section.

4. Sealing system according to one of the preceding claims, characterized in that at least one main expansion chamber (57a, 57b) is formed by a cross-sectional shape of the sealing channel (22) receiving it diverging from the basic cross-sectional shape of the sealing ring (14) and in particular by a profile, indented compared with a semicircular shape, of the channel halves forming the sealing channel (22).

5. Sealing system according to claim 4, characterized in that the cross-sectional profile of the channel halves comprises a semicircular arc (61, 61b) and a straight or slightly curved portions (59a, 59b, 60a, 60b) connecting tangentially thereto and to whose ends are connected the main sealing surfaces (34a, 34b, 40a, 40b), which are preferably formed in the vicinity of the portions of the parts engaging in the sealing ring cross-section.

6. Sealing system according to one of the preceding claims, characterized in that a secondary expansion chamber (35) is provided at the transition between the sealing channel (22) and the separating gap (41) and forms a cross-sectionally bead-shaped depression with rounded edges projecting over the annular channel (22).

7. Sealing system according to claim 6, characterized in that the depression passes with a S-shaped transition (37) into the sealing channel (22).

8. Sealing system according to one of the preceding claims, characterized in that the sealing gap (41) is axially connected to the secondary expansion chamber (35) and is preferably so narrow, particularly no wider than 1/100 to 1/10, particularly 1/80 to 1/50 of the cross-sectional dimension of the sealing ring (14), that the deformation of the sealing ring (14) ends before it.

9. Sealing system according to one of the preceding claims, characterized in that the sealing channel (22) and its expansion chamber (35, 57a, 57b) are so dimensioned as a function of the dimensions of the sealing ring (14) that the surface of the part of the sealing ring (14) deforming into the sealing gap (30) is substantially aligned with the media-carrying walls of the parts.

10. Sealing system according to the preamble of claim 1, characterized in that the boundary edges (31a, 31b, 36) of the sealing gap (30) connected to the sealing surface (21a, 21b) are provided with a uniform and predetermined radius independent of the tolerance-variable thickness of the edge.

11. Sealing system according to claim 10, characterized in that the size of the radius is 1/20 to ⅓, preferably 1/10 to ⅕ of the cross-sectional dimension of the sealing ring (14).

12. Sealing system according to claim 10, characterized in that the cross-sectional dimension of the sealing ring (14) is small compared with the nominal width of the media-carrying parts and is preferably 1/150 to 1/10, particularly 1/100 to 1/50 of the nominal width of the media-carrying parts.

13. Sealing system according to one of the preceding claims, characterized in that the sealing ring (14) is made from hard metal, particularly ferrotitanate and the parts are deformable under the bracing force.

14. Sealing system according to one of the preceding claims, characterized in that for the connection of the media-carrying parts a screw coupling (11) is provided and has in particular a coating preventing corrosion during the screwing action (11) and which is preferably a titanium-nitride coating.

15. Sealing system according to one of the preceding claims, characterized in that the sealing system is a joint connection between two media-carrying parts, particularly between two pipes.

16. Sealing system according to one of the preceding claims, characterized in that the parts are made from a hard material, particularly metal, such as stainless steel or plastic.
